(19) United States
(12) Patent Application Publication
(10) Pub. No.: US 2017/0274466 A1
(43) Pub. Date: Sep. 28, 2017

(54) TOOLING ADAPTED FOR BRAZING A SET OF PARTS

(71) Applicant: SAFRAN NACELLES, GONFREVILLE L'ORCHER (FR)

(72) Inventors: Philippe BIENVENU, GONFREVILLE L'ORCHER (FR); Jean-Claude RIVOAL, GONFREVILLE L'ORCHER (FR); Guillaume THERON, GONFREVILLE L'ORCHER (FR)

(73) Assignee: SAFRAN NACELLES, GONFREVILLE L'ORCHER (FR)

(21) Appl. No.: 15/619,968

(22) Filed: Jun. 12, 2017

Related U.S. Application Data
(63) Continuation of application No. PCT/FR2015/053599, filed on Dec. 17, 2015.

(30) Foreign Application Priority Data
Dec. 17, 2014 (FR) 14/62656

(51) Int. Cl. B23K 3/08; B23K 1/00

(52) U.S. Cl. CPC B23K 3/087; B23K 1/0014; B23K 2201/02

(57) ABSTRACT

The present disclosure relates to a brazing tooling for the manufacture of a part, and in particular to a tooling adapted for brazing a set of metallic parts, in particular a composite panel, in an enclosure of a brazing furnace. The tooling includes a first mold element and a second mold element clasped together and a bearing device. The first and the second mold elements respectively include a first material and a second material, the first material having an expansion coefficient greater than the expansion coefficient of the material of the set of parts, and the second material having an expansion coefficient lower than the expansion coefficient of the material of the set of parts. At the brazing temperature, constraining of the set of parts between the bearing device of the first and second mold elements is provided.

### CROSS-REFERENCE TO RELATED APPLICATIONS

This application is a continuation of International Application No. PCT/FR2015/053599, filed on Dec. 17, 2015, which claims priority to and the benefit of FR 14/62656 filed on Dec. 17, 2014. The disclosures of the above applications are incorporated herein by reference.

### FIELD

The present disclosure relates to a brazing tooling for the manufacture of a part.

### BACKGROUND

The statements in this section merely provide background information related to the present disclosure and may not constitute prior art.

Brazing tooling finds application in particular in the aeronautical field, and more particularly for the manufacture of composite panels having a sandwich structure formed by a central core having a honeycomb-type alveolar core structure sandwiched between two skins.

These composite panels may also consist of acoustic attenuation panels provided to reduce the noise emissions of the turbojet engines, these panels having generally a sandwich structure comprising:

an outer (oriented towards the source of noise), air-permeable, perforated skin, called “resistive” or “acoustic” skin, the role of which is to dissipate the acoustic energy,

a honeycomb-type alveolar core structure, and

an inner skin formed by a solid skin (opposite to the source of noise), called structuring skin.

In some cases, the composite panels have to be designed to be installed in a hot area of an aircraft turbojet engine nacelle, and in particular in the downstream portion of this nacelle by which exhaust gases are expelled.

In general, such composite panels are used for structural purposes and, when they consist of acoustic attenuation panels in this exhaust area, this also allows substantially reducing the sound emissions located in the high frequencies range.

For the particular applications at high temperature, there is generally used composite panels whose skins are formed by a sheet metal and whose alveolar core structure is also metallic.

The alveolar core structure may then be linked to the sheet metals by brazing.

By definition, brazing is a method for assembling two elements using a filler metal whose melting temperature is lower than the melting temperature of the base metal of the elements. By bringing the filler metal to its melting temperature, said filler metal liquefies and wets the base metal with which it is in contact and then spreads inside the said base metal. Afterwards, by cooling the assembly, the filler metal is solidified and provides the linkage between the different elements in contact.

Such assembly operations of the composite panels are delicate to the extent that there is a risk that the structural, and possibly acoustic, qualities of the panel are affected by these operations: for example, an insufficient mechanical strength of the panel, or even a loss of acoustic absorption of the panel if it consists of an acoustic attenuation panel.

An improper relative positioning of the constitutive elements of the panel after brazing may have an impact on these structural and even acoustic qualities of the composite panel.

Thus, it is desired to be able to control at best the relative positioning of the parts intervening during the brazing and the solder, namely the contact between the brazed elements.

Moreover, the assembly operations may affect the metallurgic properties of the treated panel and have an impact on the surface properties of said panel, which may reduce the aerodynamic performances thereof.

There are already known devices for assembling parts to be brazed in which constraint forces are exerted on the parts to be brazed in order to provide a sufficient contact pressure between the parts and to compensate the expansions of the said parts.

These forces tend to avoid the deformations of the parts during the brazing and to maintain them in the shape and in the relative positioning thereof.

If not controlled, these deformations generate brazing defects such as a poor quality of the solder connections or a local absence of connection.

A known device proposes using tie members to apply a mechanical pressure on the elements to be brazed, during the brazing.

Nonetheless, one of the drawbacks of such a device is that, during the cooling step, and because of the different materials used, geometric conflicts occur tending to deform the parts to be brazed.

In order to limit both these geometric conflicts during the cooling step, and the frictions between the tooling and the parts to be brazed because of the different expansions of these materials which constitute them, it is known to use, in order to clasp the parts to be brazed, a tooling formed by a material having an expansion coefficient close to the expansion coefficient of the material of the parts to be brazed.

For example, in the case where the parts to be brazed are made of titanium, with an expansion coefficient equal to 10.3×10⁻⁶ K⁻¹ and intended to form a composite panel, it is known to use tooling made of refractory concrete with an expansion coefficient equal to 8.1×10⁻⁶ K⁻¹ because of its expansion coefficient close to the expansion coefficient of titanium.

Nonetheless, the use of refractory concrete in this context has numerous drawbacks. In particular, this material has a very high thermal inertia which generates too long brazing times, does not support heating and cooling speeds greater than 2.5° C./mm to the risk of cracking and is easily moistened which is not compatible with the need of creating vacuum in brazing furnaces.

Moreover, it is very difficult to obtain a homogeneous temperature with a tooling made of refractory concrete, which requires the use of an additional temperature homogenization device.

Another challenge relating to the tooling adapted for the brazing of a composite panel is that of resistance to temperature. Indeed, the more the composite panel obtained after the brazing has to resist significant thermal constraints, as it is the case in particular for applications on turbojet engine nacelles of aircrafts, and the higher the brazing temperature should be.

The materials which may form a tooling adapted for the brazing such a set of parts, for example at a brazing temperature of 1000° C., are generally expensive, can withstand a number of reduced cycles and generate too long brazing times because of their thermal inertia.

### SUMMARY

The present disclosure provides tooling adapted for the brazing a set of metallic parts, in particular of a composite panel, in an enclosure of a brazing furnace, the tooling comprising at least one first mold element and one second mold element adapted to clasp together, at the brazing temperature, the set of parts, the first and second mold elements comprising at least one bearing device forming a mold against which the set of parts is placed under constraints at said brazing temperature, the tooling being noteworthy in that the first and the second mold elements comprise respectively a first material and a second material:

the first material having an expansion coefficient greater than the expansion coefficient of the material of the set of parts; and

the second material having an expansion coefficient lower than the expansion coefficient of the material of the set of parts;

the first and second materials being adapted so that their expansion, at least at the brazing temperature, provides the constraining of the set of parts between the bearing device of the first and second mold elements.

Thanks to such tooling, the mechanical pressure exerted by the bearing device of the first and second mold elements is provided by the expansion of the first and second materials during the increase of the temperature in the brazing furnace, up to the brazing temperature.

The first and second materials having an expansion coefficient different from the expansion coefficient of the material of the set of parts to be brazed, it then becomes possible to disregard the expansion coefficient of the material to be brazed, such as the expansion coefficient of titanium for example.

The choice of such materials, withstanding significant brazing temperatures, for example in the range of 1000° C., becomes wider and no longer restricted to a limited number of materials having all or part of the aforementioned drawbacks.

Moreover, because, on the one hand, the first, respectively the second, material has a greater, respectively lower, expansion coefficient than the expansion coefficient of the material of the set of parts, and because, on the other hand, the first and second materials are adapted so that their expansion during the brazing provides the constraining of the set of parts between the bearing device of the first and second mold elements, this results in that, during the cooling step, the mechanical constraints exerted by the bearing device on the parts assembled by the brazing will progressively decrease.

Thus, as the temperature decreases, the set of brazed parts is free to cool down and to be retracted since the constraints exerted by the bearing device is concomitantly reduced.

According to an advantageous particular configuration, the bearing device of the first mold element is held by first tie members formed by the first material and/or the bearing device of the second mold element is held by second tie members formed by the second material.

In this case, and advantageously, the first mold element comprises two bearing device each fastened to opposite ends of the associated first tie members and the second mold element comprises two bearing device each fastened to opposite ends of the associated second tie members, the second mold element delimiting an inner space inside which the first mold element is placed so that each of the bearing device of the first mold element is facing one of the bearing device of the second mold element.

Such a configuration enables in particular brazing two sets of parts at the same time with the same tooling, this without increasing the heating and cooling time of the brazing.

Alternatively, the bearing device of the first and second mold elements are constituted at least partially by the first and by the second materials respectively. Such a configuration is particularly advantageous, in particular in the case where the set of parts to be brazed forms a revolving part.

Still advantageously, the first and second bearing device is disposed generally vertically so that the set of metallic parts is vertically clasped, at the brazing temperature.

In this configuration, the constraints exerted by the bearing device is still limited since the action of the weight of the set of parts on the bearing device is limited, and even suppressed. Indeed, in the opposite case where the first and second bearing device would be disposed generally horizontally so that the set of metallic parts is horizontally clasped, at the brazing temperature, the force of gravity exerted by the set of parts on the bearing device which supports it implies a resulting constraint exerted on a wide surface of the set of parts, which is at the origin of frictions between the tooling and the parts to be brazed during the cooling.

With a vertical orientation, on the one hand, the bearing device does not support the set of parts, and on the other hand, the frictions undergone by the set of parts are significantly reduced. Thus, the composite panel is cleared naturally from the bearing device. This is particularly advantageous for the brazing elements of large-size parts, for example composite panels having a surface area of several square meters.

According to a particular feature, a spacing between the bearing device of the first and second mold elements is chosen so as to have a determined spacing or a determined constraint at the brazing temperature.

In a particular configuration, the bearing device is made of carbon/carbon or of a refractory stainless steel or of graphite.

Advantageously, the first material is a refractory stainless steel.

Still in another form, the second material is made of molybdenum or of carbon/carbon.

According to a particular technical configuration, the set of parts is a composite panel, in particular an acoustic attenuation panel.

According to another aspect, the present disclosure concerns a brazing furnace comprising a tooling as described hereinbefore.

Thanks to the present disclosure, the risks of deformations are suppressed and the heating and cooling times are reduced. Moreover, it is possible to use high brazing temperatures, in particular greater than 1000° C.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a general representation of a turbojet engine nacelle for an aircraft;

FIG. 2 illustrates an exploded view of the inner fixed structure 8 of the nacelle of FIG. 1;

FIG. 3 is a perspective view, illustrating hidden lines, of tooling for the brazing of a set of metallic parts such as a composite panel according to one form of the present disclosure;

FIG. 4 is a cross-sectional view of the tooling of FIG. 3;

FIG. 5 illustrates tooling for the brazing of a set of metallic parts such as a composite panel according to another form of the present disclosure;

FIG. 6 illustrates tooling for the brazing of a set of metallic parts such as a composite panel according to yet another form of the present disclosure;

FIGS. 7a and 7b illustrate tooling for the brazing of a set of metallic parts such as a composite panel according to still another form of the present disclosure; and

FIG. 8 illustrates tooling for the brazing of a set of metallic parts such as a composite panel according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

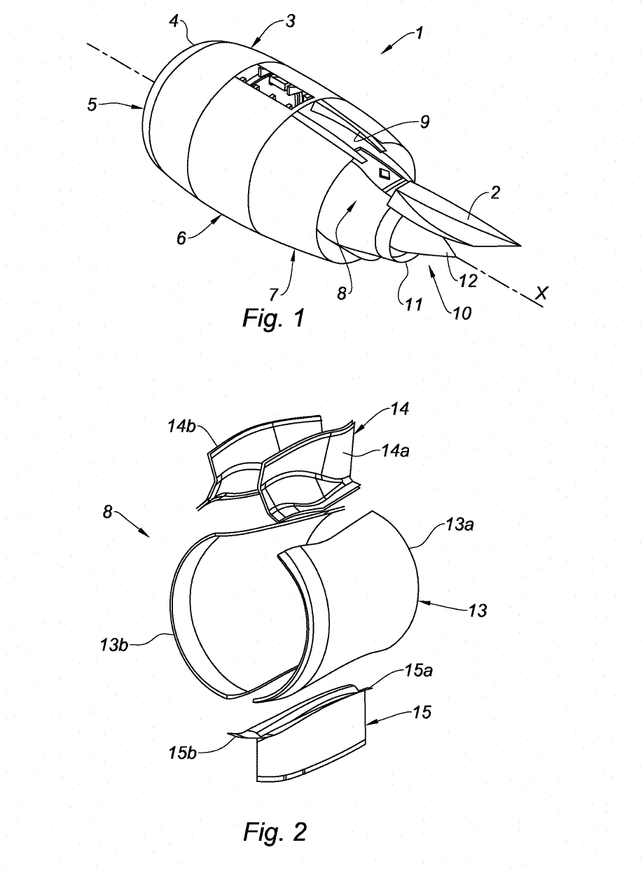

As represented in FIG. 1, a nacelle 1 has a substantially tubular shape according to a longitudinal axis X. This nacelle 1 is intended to hang from a pylon 2, which is in turn fastened under a wing of an aircraft.

In general, the nacelle 1 comprises a front or upstream section 3 with an air inlet lip 4 forming an air inlet 5, a mid-section 6 surrounding a fan of a turbojet engine (not represented) and a rear or downstream section 7. The downstream section 7 comprises an inner fixed structure 8 (IFS) surrounding the upstream portion of the turbojet engine, and an outer fixed structure (OFS) 9.

The IFS 8 and the OFS 9 delimit an annular flow path allowing the passage of a main air flow penetrating the nacelle 1 at the air inlet 5.

Therefore, the nacelle 1 includes walls delimiting a space, such as the air inlet 5 or the annular flow path, in which the main air flow penetrates, circulates and is ejected.

The nacelle 1 is ended by an ejection nozzle 10 comprising an outer module 11 and an inner module 12. The inner 12 and outer 11 modules define a hot air flow channel coming out of the turbojet engine.

FIG. 2 illustrates and exploded view of the inner fixed structure 8 of the nacelle 1. In this form, the IFS 8 comprises a barrel 13 composed of two substantially semi-circular shaped walls 13a, 13b each forming a half-barrel so that, once assembled, these walls 13a, 13b form the generally cylindrical shaped barrel 13 with a longitudinal axis X.

Moreover, the IFS comprises two islets 14, 15 for providing a structural linkage between the IFS and the OFS. One of which 14, called 12H islet, is arranged to be placed vertically above the barrel, and the other 15, called 6H islet, is arranged to be placed vertically below the barrel. Each of these islets 14, 15 is herein composed of two sets of parts 14a, 14b, 15a, 15b, each being intended to be assembled with one of the walls forming a half-barrel.

The sets of parts composing in particular this IFS 8, like numerous other parts of the nacelle, are generally composite panels composed of several parts, namely two skins and one central core having a honeycomb-type alveolar core structure sandwiched between the two skins. These composite panels offer a weight gain and an improved strength.

Nonetheless, their manufacture is delicate because of the structural, thermal and even acoustic constraints that these composite panels should meet.

The present disclosure described hereinafter is particularly advantageous in the context of the manufacture of these composite panels, intended to equip a nacelle.

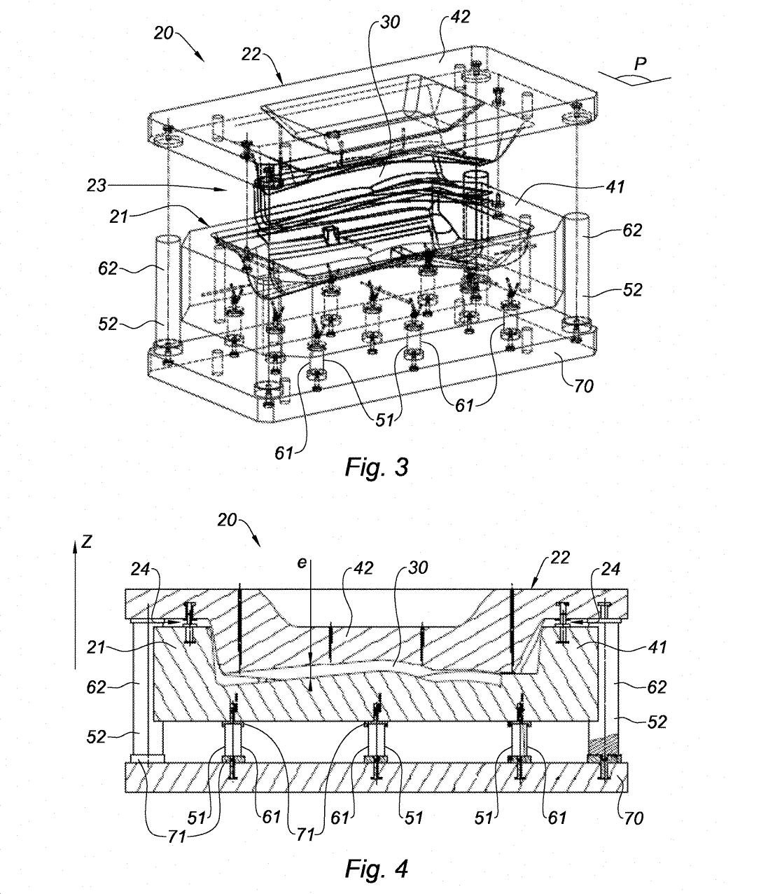

FIGS. 3 and 4 illustrate tooling 20 for the brazing a set 30 of metallic parts such as a composite panel according to one form of the present disclosure.

This tooling is intended to be placed in an enclosure of a brazing furnace (not represented in these two figures).

The tooling 20 comprises herein a first mold element 21 and a second mold element 22 adapted to clasp together, at the brazing temperature, the set of parts 30.

The first and second mold elements 21, 22 each comprise a bearing device 41, 42 forming a mold against which the set 30 of parts is placed under constraints at said brazing temperature. It is contact surfaces of these bearing device 41, 42 which will form an interface with the set of parts to be brazed and exert the constraints during the brazing.

The set of parts to be brazed is herein one of the panels intended to form the 12H or 6H islet 14, 15 of an IFS 8 of a nacelle 1. This panel is a composite panel having a sandwich structure formed by a central core having a honeycomb-type alveolar core structure, which is sandwiched between two skins. The alveolar core structure and the skins each is made of titanium.

During the brazing, the bearing device 41, 42 of the first and second mold elements 21, 22 are each brought in opposition against each of the titanium skins of the composite panels and clasp the set 30 of these parts, namely the skins against which the bearing device 41, 42 come into contact and bear during the brazing, and the core located between the skins.

The first and second mold elements 21, 22 comprise respectively a first material 51 and a second material 52:

the first material 51 having an expansion coefficient greater than the expansion coefficient of the material of the set 30 of parts, that is to say in this instance titanium; and

the second material 52 having an expansion coefficient lower than the expansion coefficient of titanium forming the composite panel 30;

the first and second materials 51, 52 being adapted so that their expansion, at least at the brazing temperature, provides the constraining of the set 30 of parts between the bearing device 41, 42 of the first and second mold elements 21, 22.

In other words, the constraining of the composite panel 30 exerted by the bearing device 41, 42 of the first and second mold elements 21, 22 is provided by the expansion of the first and second materials 51, 52 itself during the increase of the temperature in the brazing furnace, up to the brazing temperature.

In this form, the bearing device 41 of the first mold element 21 is held by first tie members 61 formed by the first material 51 and the bearing device 52 of the second mold element 22 is held by second tie members 62 formed by the second material 52.

In particular, each of the first and second tie members 61, 62 are disposed substantially according to a vertical axis Z, that is to say perpendicularly to a ground plane on which the tooling 20 rests, and are secured, on the one hand, at a lower end to a common base plate 70 and, on the other hand, at an upper end, to an associated bearing device 41, 42.

In other words, the tooling 20 comprises:

a base plate 70 resting on the ground extending horizontally;

the first mold element 21 comprising a bearing device 41 extending generally horizontally, that is to say generally in a plane P parallel to the ground plane, and fastened to the base plate by nine first tie members 61 risen vertically; and

the second mold element 22 comprising a bearing device 42 extending generally horizontally and fastened to the base plate by four second tie members 62 risen vertically;

the second mold element 22 delimiting with the base plate 70 an inner space 23 inside which the first mold element 21 is placed.

The second material 52 of the second tie members is herein molybdenum having an expansion coefficient substantially equal to 5×10⁻⁶ K⁻¹.

The bearing device 41 of the first mold element 21 is, in turn, supported by the first tie members 61 formed by the first material 51, herein a refractory stainless steel with an expansion coefficient substantially equal to 19×10⁻⁶ K⁻¹, that is to say expanding four times more than molybdenum.

The first tie members 61 form expansion bars and the second tie members form retention bars.

Thus, under the effect of the temperature inside the enclosure of a brazing furnace, the bearing device 41 of the first mold element 21, which is located under the set of parts 30 that it supports, is raised as the temperature increases and is brought to press the parts to be brazed against the bearing device 42 of the second mold element 22 located above the set of parts 30, the bearing device 41, 42 of the first and second mold elements 21, 22 thus clasping the composite panel 30.

Once the brazing is complete and when the temperature decreases, the bearing device 41 of the first mold element 21 lowers as the temperature decreases, in particular relative to the bearing device 42 of the second element because of the difference of expansion coefficient, and releases said composite panel 30 from the bearing device 42 of the second mold element 22 against which said composite panel 30 is under constraints during the brazing. Therefore, the composite panel 30 can cool down and be freely retracted without being clasped, that is to say without undergoing the constraints exerted by the bearing device on said composite panel 30 during the brazing.

Therefore, this configuration forms a “thermal elevator” the temperature of which in the enclosure of the brazing furnace develops a spacing “e” between the first and second bearing device 41, 42 of the first and second mold elements 21, 22 thereby providing the constraining of the composite panel 30 by said bearing device 41, 42.

The variation of this spacing is allowed due to the fact that the respective heights of the bearing device 41, 42 of the first and second elements 21, 22 evolve in a different and controlled manner since the first mold element 21 is located in the inner space 23 delimited by the second mold element 22 with the base plate 70, the bearing device 41 of the first mold element 21 being located under the bearing element 42 of the second mold element 22 with respect to the vertical, and since:

the stainless steel 51 of the first tie members 61 has an expansion coefficient greater than the expansion coefficient of the titanium of the composite panel 30; and

the molybdenum 52 of the second tie members 62 has an expansion coefficient lower than the expansion coefficient of titanium.

Stops 24 may be placed between the bearing device 41, 42 of the first and second mold elements 21, 22 so as to avoid a too significant crushing of the composite panel 30. In this case, these anti-crush stops will be placed on a peripheral area of the bearing device 41, 42 and outside or beyond the contact and bearing area where the constraints are exerted on the composite panel (see FIG. 4). Advantageously, as it is the case in this form, the stops comprise at least one centering device allowing centering the position of the bearing device 41, 42 with respect to each other. This centering device may for example be formed by conical-shaped protrusions arranged to penetrate in adapted orifices.

The fastening of the tie member with the associated bearing device and the base plate 70 is achieved by screws located in the longitudinal extension of the tie member at the lower end. In particular, the tie members 61, 62 are screwed on bowls 71 which are in turn sealed in the refractory concrete of the base plate 70. Bowls 71 are also positioned at their upper end, the bearing device 41, 42 of the first and second mold elements 21, 22 resting on said bowls 71 carried by the tie members 61, 62. Although the bearing device 41, 42 are placed on the tie members 61, 62, the mass of the bearing device 42 of the second element 22 is sufficient to exert, during the brazing, the required pressure.

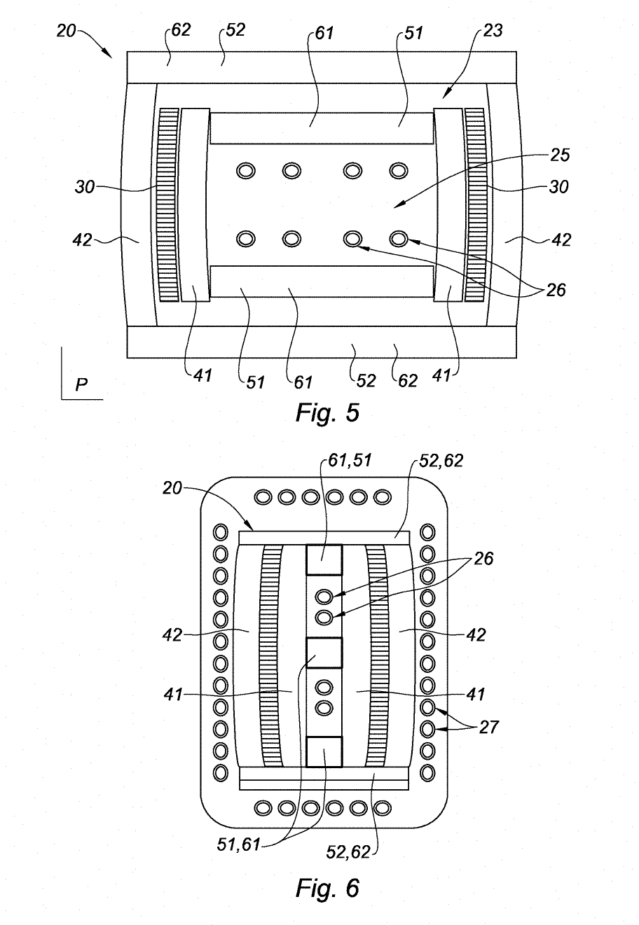

FIG. 5 schematically illustrates a tooling 20 for the brazing of a set 30 of metallic parts such as a composite panel according to a second form of the present disclosure.

This second form differs essentially from the first form illustrated in FIGS. 3 and 4 in that it comprises:

a first mold element 21 comprising two bearing device 41 each fastened to opposite ends of the associated first tie members 61; and

a second mold element 22 comprising two bearing device 42 each fastened to opposite ends of the associated second tie members 62,

the second mold element 22 delimiting, with its bearing device 42 and its second tie members 61, an inner space 23 inside which the first mold element 21 is placed, so that each of the bearing device 41 of the first mold element 21 faces one of the bearing device of the second mold element.

Such a configuration enables in particular implementing the brazing of two sets 30 of parts at the same time with the same tooling 20 and in the same enclosure of the furnace, this without increasing the heating and cooling time of the brazing.

Another difference in comparison with the first form is that, in this second form, the first and second bearing device 41, 42 are disposed generally vertically, that is to say generally perpendicular to the ground plane, so that the set 30 of metallic parts is clasped, at the brazing temperature, vertically. The first and second tie members 61, 62 are then disposed in a plane P parallel to the horizontal plane.

The first material 51 is herein stainless steel and the second material 52 is molybdenum, these materials constituting the first and second tie members 61, 62 respectively.

The constraints exerted by the bearing device 41, 42 are significantly limited since the action of the weight of the composite panel 30 on the bearing device is limited, and even suppressed.

Indeed, in the opposite case where the first and second bearing device 41, 42 are disposed horizontally, as illustrated in FIGS. 3 and 4, so that the composite panel 30 is clasped, at the brazing temperature, horizontally, the force of gravity exerted by the composite panel 30 on the bearing device 41 (see FIG. 4) which supports it implies a constraint exerting on a wide surface of the composite panel 30 delimited by the associated skin thereof and which is underlying frictions between the tooling 20 and said composite panel 30 during the cooling.

With a vertical orientation, the bearing device 41, 42 do not support as such the composite panel. Moreover, in such a configuration, the composite panel, then risen vertically, would rest on a support against its face delimiting a thickness of the composite panel 30, this thickness having a very small dimension in comparison with the other dimensions of the composite panel. This results in that the frictions undergone by the composite panel 30 are significantly reduced.

Moreover, the first mold element 21 delimits, herein in particular but in a non-restrictive manner, with the bearing device 41 and the tie members 61 thereof, another inner space 25.

The use of one or several metallic material(s) to form said first mold element 21, in this case molybdenum, and the presence of an inner space 25, allows installing a network of inner resistances 26 so as to provide, together with another network of outer resistances 27 carried by the furnace (see FIG. 6), a better homogeneity of the temperature with respect to the composite panels 30 during the brazing.

In these configurations, the two inner (since they are located in the inner space 23) bearing device 41 are pushed by the first tie members 61 or expansion bars made of refractory stainless steel 51 providing the shaping and the fitting of the two composite panels 30 on the two outer bearing device 42 held by the second tie members 62 made of molybdenum 52 barely expanding throughout the duration of brazing at about 1000° C. Alternatively, the molybdenum may be replaced with carbon/carbon.

During the cooling, the two inner bearing devices 41 are retracted via the first tie members 61 or expansion bars made of refractory stainless steel 51 on which they are attached and free the brazed composite panels from their constraints.

The fastening of the tie members with the associated bearing device is performed by screws located in the longitudinal extension of the tie member at each of its two, lower and upper, ends.

Since the different materials may include considerable expansion deviations and since the dimensions of the parts constituted by these materials may be relatively large, the fastening of the tie members with the associated bearing device may be performed using housings adapted to accept the respective expansions.

FIG. 6 schematically illustrates a tooling 20 for brazing a set 30 of metallic parts such as a composite panel according to a third form of the present disclosure. This third form may be combined with the second form illustrated in FIG. 5.

In this third form, unlike the second form, the second tie members 62 of the second mold element 22 formed by the second material 52 as well as the bearing device 41, 42 of the first and second mold elements 21, 22 are made of carbon/carbon with an expansion coefficient substantially equal to 2×10⁻⁶ K⁻¹.

The first tie members 61 are constituted by the first material 51, herein stainless steel with an expansion coefficient substantially equal to 19×10⁻⁶ K⁻¹, that is to say expanding almost four times more than molybdenum.

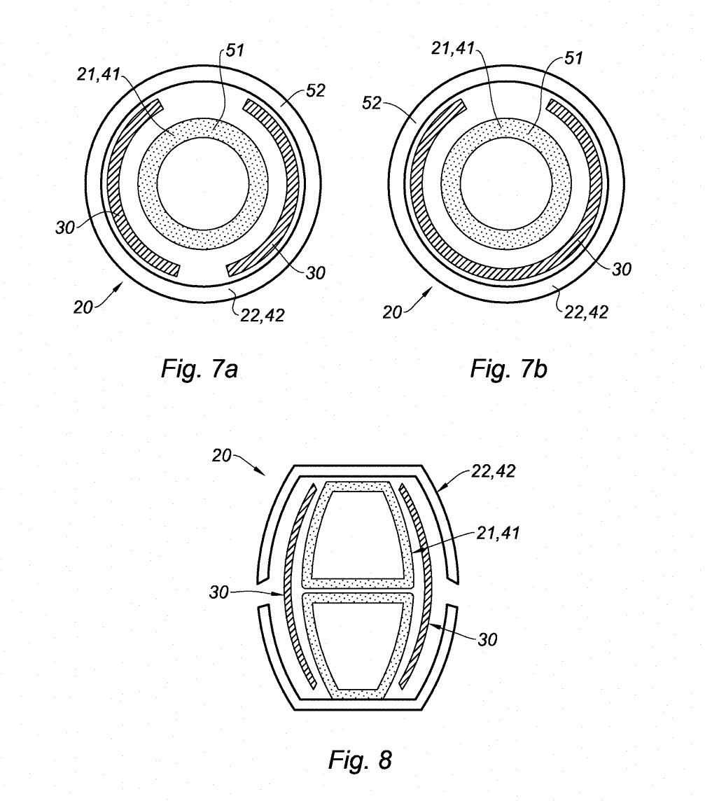

FIGS. 7a and 7b schematically illustrate a tooling for brazing a set of metallic parts such as a composite panel 30 according to a fourth form of the present disclosure.

The bearing device 41, 42 of the first and second mold elements 21, 22 each have a substantially circular section, with a vertical axis of revolution and are constituted at least partially by the first and the second material 51, 52, respectively.

The bearing device 41 of the first mold element 21 has a section with a closed contour forming an inner crown and the bearing device 42 of the second mold element 22 has a section with a closed contour forming an outer crown. FIGS. 7a and 7b illustrate cross-sectional view, in a plane parallel to the ground plane.

In other words, the second bearing device 42, with a substantially circular section delimits an inner space 23 inside which the first bearing device 41 is placed. Such a configuration allows avoiding the need to use tie members and brazing composite panels 30 having an axis of revolution, herein vertical. These composite panels 30 may for example be cylindrical, conical, truncated-cone shaped, etc.

In general, the inner space 23 is arranged to receive one or several composite panel(s) having a circle-arc section extending over a more or less wide angular sector. For example, FIG. 7a illustrates an inner space 23 inside which two composite panels are placed each having a circle-arc shaped section and each extending over an angular sector lower than 180°. FIG. 7b illustrates an inner space 23 inside which a composite panel is placed having a circle-arc shaped section and extending over an angular sector greater than 270° and strictly lower than 360°.

For example, the composite panel 30 may be intended to form an inner module 12 of the ejection nozzle 10 of the nacelle 1, as illustrated in FIG. 1, or even intended to form a barrel 13 of an IFS 8 made of titanium.

Because of the absence of tie members, the bearing device 41, 42 form, at least partially, the first and second mold elements 21, 22, and are formed by the first material 51 and by the second material 52, respectively.

The set 30 of parts to be brazed is interposed between the first and second elements 21, 22 and, in the same manner as the other forms:

the first material 51 has an expansion coefficient greater than the expansion coefficient of the material of the set 30 of parts, that is to say in this instance titanium; and

the second material 52 has an expansion coefficient lower than the expansion coefficient of titanium forming the composite panel 30.

the first and second materials 51, 52 being adapted so that their expansion, at least at the brazing temperature, provides the constraining of the set 30 of parts between the bearing device 41, 42 of the first and second mold elements 21, 22.

FIG. 8 illustrates a tooling for brazing a set of metallic parts such as a composite panel according to another form of the present disclosure. FIG. 8 illustrates a longitudinal sectional view, in a vertical plane, perpendicular to the ground plane.

In this form, in this instance complementarily with that illustrated in FIGS. 7a and 7b, the tooling 20 may open into two portions so as to facilitate the removal of the part, in particular when the composite panel 30 is intended to form a barrel 13.

More specifically, in this form, the bearing device 41, 42 of the first and second mold elements 21, 22 each include a lower portion and an upper portion, each having a half-barrel shape and placed facing each other. The upper portions are herein placed on the lower portions of the first and second elements 21, 22 respectively.

In order to provide the anchoring of the upper portion on the associated lower portion, an anchoring device (not represented) may be provided such as a circular lip on an edge of the lower portion arranged to cooperate in a circular groove on an edge of the upper portion, or vice versa.

Moreover, reinforcing circular strappings may be used in complement to reinforce the mechanical strength of the first and second elements 21, 22.

The present disclosure is described in the foregoing as example. It is understood that those skilled in the art are capable of realizing different variants of the present disclosure without actually departing from the scope of the present disclosure.

For example, the first and second bearing device 41, 42 may be disposed generally vertically so that the set of metallic parts is clasped, at the brazing temperature, vertically even though the first and second elements each have one single bearing device 41, 42.

The tooling may also be used or associated in combination with mechanical pressing device to apply an additional pressure on the elements to be brazed, during the brazing.

The first and second materials are chosen so that they comply with the condition regarding their respective expansion coefficient with respect to the expansion coefficient of the set 30 of parts to be brazed. Therefore, the mentioned materials may vary depending on said expansion coefficients. In one form, these first and second materials are metallic.

Moreover, the first and second materials 51, 52 may comprise a combination of materials, so that this alloy has an appropriate expansion coefficient.

Moreover, when tie members are used, as illustrated in FIGS. 3, 4, 5 and 6) said tie members may be entirely or partially formed by the first or second material. This configuration allows determining more easily the spacing between the bearing device 41, 42 of the first and second mold elements 21, 22 considering the dimensions of the tooling and the desired spacing, that is to say the constraints to be determined, at the brazing temperature.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. Tooling for brazing a set of metallic parts of a composite panel, in an enclosure of a brazing furnace, the tooling comprising:
a first mold element;
a second mold element adapted to clasp together with the first mold element at a brazing temperature; and
at least one bearing device forming a mold against which the set of metallic parts is placed under constraints at said brazing temperature,
wherein the first and the second mold elements respectively comprise a first material and a second material, the first material having an expansion coefficient greater than an expansion coefficient of a material of the set of metallic parts, and the second material having an expansion coefficient lower than the expansion coefficient of the material of the set of metallic parts, and
wherein the first and second materials are adapted so that their thermal expansion, at least at the brazing temperature, constrains the set of metallic parts between the bearing device of the first and second mold elements.

2. The tooling according to claim 1, wherein the at least one bearing device is held by tie members.

3. The tooling according to claim 1, wherein the first mold element comprises two bearing devices fastened to opposite ends of associated first tie members, and the second mold element comprises two bearing devices fastened to opposite ends of associated second tie members, the second mold element delimiting an inner space inside which the first mold element is placed so that at least one bearing device of the first mold element is facing at least one bearing device of the second mold element.

4. The tooling according to claim 1, wherein the at least one bearing device of the first and second mold elements are constituted at least partially by the first and the second materials respectively.

5. The tooling according to claim 1, wherein the at least one bearing device of the first and second mold elements is disposed vertically so that the set of metallic parts is vertically engaged, at the brazing temperature.

6. The tooling according to claim 1, wherein a spacing between the at least one bearing device of the first and second mold elements is chosen so as to have a determined spacing or a determined constraint at the brazing temperature.

7. The tooling according to claim 1, wherein the at least one bearing device is a material selected from the group consisting of of carbon/carbon, a refractory stainless steel, and graphite.

8. The tooling according to claim 1, wherein the first material is a refractory stainless steel.

9. The tooling according to claim 1, wherein the second material is a material selected from the group consisting of molybdenum and carbon/carbon.

10. The tooling according to claim 1, wherein the set of metallic parts is a composite panel, in particular an acoustic attenuation panel.
